(19) United States
(12) Patent Application Publication
(10) Pub. No.: US 2004/0001698 A1
(43) Pub. Date: Jan. 1, 2004

(54) Moving image reproducing apparatus

(75) Inventor: Shigekazu Morikawa, Osaka (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: Sanyo Electric Co., Ltd., Moriguchi-shi (JP)

(21) Appl. No.: 10/606,219

(22) Filed: Jun. 26, 2003

(30) Foreign Application Priority Data
Jun. 28, 2002 (JP) 2002-188904

(51) Int. Cl. H04N 5/783; H04N 5/225

(52) U.S. Cl. 386/69; 386/120

(57) ABSTRACT

A moving image reproducing apparatus includes an NIC. Still image data of respective frames forming moving image data fetched from the NIC is compressed still image data compressed in accordance with a JPEG 2000 format. When such the compressed still image data is expanded, a CPU decodes, in the order that is from a lower frequency, a plurality of EBC blocks forming one frame of the compressed still image data. However, a decoding amount of the EBC blocks is controlled based on a frame rate of the moving image data. The still image data corresponding to decoded frequency components is multiplexed with each other by an inverse DWT processing, thereby generating one screen of expanded still image data.

### BACKGROUND OF THE INVENTION

1. Field of the Invention

The present invention relates to a moving image reproducing apparatus. More specifically, the present invention relates to a moving image reproducing apparatus that reproduces a plurality of blocks of encoded image data generated by encoding, by each frequency component, still image data forming moving image data.

2. Description of the Prior Art

There is a format called the JPEG 2000 for compressing image data. In this format, one screen of the image data is divided into a plurality of frequency components by a DWT processing (DWT: Discrete Wavelet Transform), and the image data of the respective frequency components is converted into codes of 0 and 1 by an EBC processing (EBC: Embedded Block Coding). Thereby, it becomes possible to reproduce an image of a high quality even in a high compression rate unlike the JPEG that adopts a DCT processing (DCT: Discrete Cosine Transform).

However, it takes time to decode a plurality of EBC blocks, and consequently, if it is intended to reproduce moving image data formed of the still image data compressed in accordance with the JPEG 2000 by a software expansion, there is a case of not being capable of retaining the same frame rate as at a time of a recording.

### SUMMARY OF THE INVENTION

Therefore, it is a primary object of the present invention to provide a moving image reproducing apparatus capable of reproducing an encoded moving image signal at a desired frame rate.

According to the present invention, a moving image reproducing apparatus that reproduces a plurality of encoded image signals generated by encoding, for each frequency component, still image signals of respective screens forming a moving image signal, comprises: a decoder for decoding, in the order of a lower frequency, a plurality of the encoded image signals corresponding to one screen; a multiplexer for multiplexing with each other a plurality of the decoded image signals decoded by the decoder so as to generate one screen of a decoded still image signal; and a controller for controlling a decoding amount by the decoder.

When reproducing a plurality of encoded image signals generated by encoding, for each low frequency component, still image signals of respective screens forming a moving image signal, a decoder decodes, in the order of a lower frequency, a plurality of the encoded image signals corresponding to one screen of the still image signal. However, a decoding amount by the decoder is controlled by a controller. A plurality of decoded image signals are multiplexed with each other by a multiplexer, thereby generating one screen of the decoded still image signal. As a result of the decoding amount being controlled by the decoder, it becomes possible to reproduce the moving image signal at a desired frame rate.

Preferably, the moving image signal is fetched by a fetcher in a real time. The controller controls the decoding amount based on a fetching period of the still image signal forming the moving image signal.

Further preferably, the controller limits the decoding amount at a time that the fetching period does not satisfy a predetermined condition, and cancels a limitation of the decoding amount when a specific mode is manually selected. Therefore, when the specific mode is selected, an image quality is prioritized.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing one embodiment of the present invention;

FIG. 2 is an illustrative view showing one portion of an operation of FIG. 1 embodiment:

FIG. 3 is a flowchart showing one portion of the operation of FIG. 1 embodiment; and

FIG. 4 is a flowchart showing another portion of the operation of FIG. 1 embodiment.

### DETAILED DESCRIPTION OF THE PREFERRED EMBODIMENTS

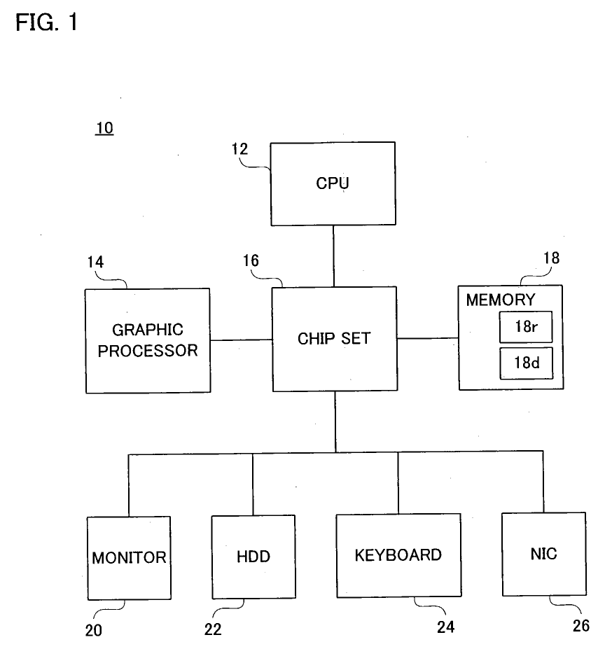

Referring to FIG. 1, a moving image reproducing apparatus 10 of this embodiment includes an NIC (Network Information Card) 26 connected to a communication network such as the Internet. Moving image data (frame rate: 30 fps) output from a WEB camera not shown is received through the NIC 26 in a real time.

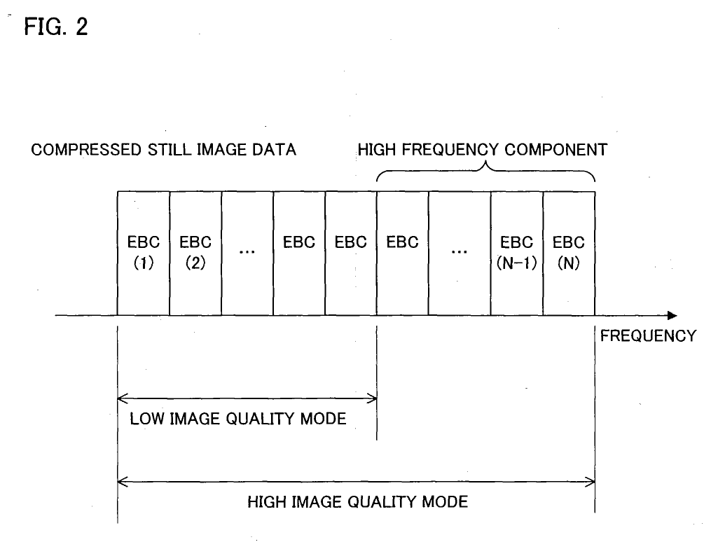

The moving image data is formed of a plurality of frames of compressed still image data to which a DWT processing and an EBC processing are applied in accordance with the JPEG 2000 format. In the DWT processing, the still image data of each frame is divided into a plurality of frequency components, and in the EBC processing, the still image data corresponding to each of the divided frequency components is converted into codes of 0 and 1. The compressed still image data of each frame is formed of N of EBC blocks as shown in FIG. 2.

The compressed still image data received through the NIC 26 is, firstly, written via a chip set 16 into a received image area 18r formed in a memory 18. The compressed still image data stored in the received image area 18r is subjected to a software expansion by a CPU 12. The expansion process follows the JPEG 2000 format, and processes are executed in the order that is from an EBC block decoding to an inverse DWT processing. N of the EBC blocks forming the compressed still image data are subjected to the EBC block decoding in the order of a lower frequency, and the still image data corresponding to N of the decoded frequency components are multiplexed with each other by the inverse DWT processing. Thereby, expanded still image data is obtained.

The expanded still image data is written in order into an expanded image area 18d formed in the memory 18 at a frame rate of 30 fps, and subjected to a drawing process by a graphic processor 14. As a result of the drawing process, a moving image based on a plurality of frames of the expanded still image data is displayed on a monitor 20.

When a frequency range of the still image data becomes larger as a result of an improved resolution of a WEB camera, a data amount of the EBC blocks, a high frequency component, in particular, is increased, and this results in taking time in decoding the EBC block. Consequently, if all the EBC blocks are decoded, there occurs a case in which the frame rate of 30 fps is not guaranteed. Therefore, in this embodiment, although all the EBC blocks are decoded when the frame rate is guaranteed, the decoding of the EBC blocks corresponding to a high frequency component is especially to be suspended when the frame rate is not guaranteed. The still image data corresponding to the high frequency component is not sufficiently obtained as a result of the EBC block decoding being suspended, thus rendering an edge of the reproduced image dull. However, the frame rate of the moving image is guaranteed.

It is noted that in this embodiment, a process in which all the EBC blocks are decoded per one frame is defined as a normal EBC block decoding, and a process in which the EBC blocks other than that of the high frequency component are decoded per one frame is defined as a high speed EBC block decoding. Furthermore, a mode that executes the normal EBC block decoding is defined as a high image quality mode, and a mode that executes the high speed EBC block decoding is defined as a low image quality mode.

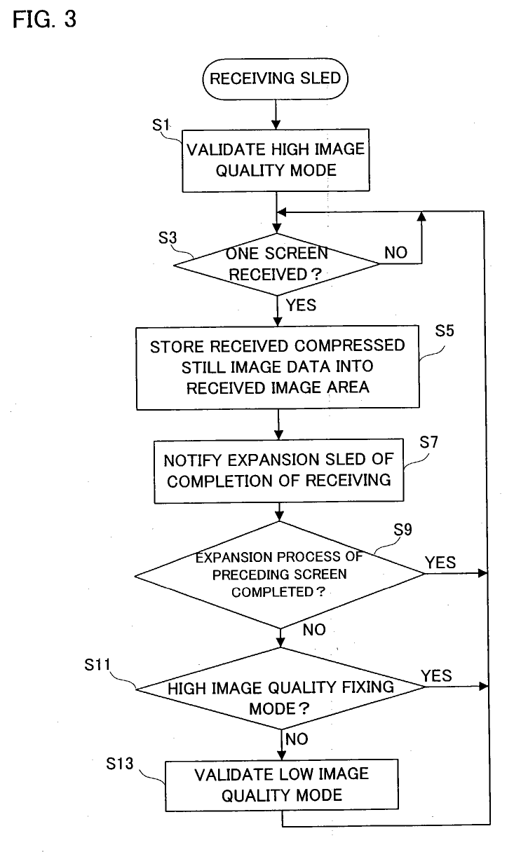

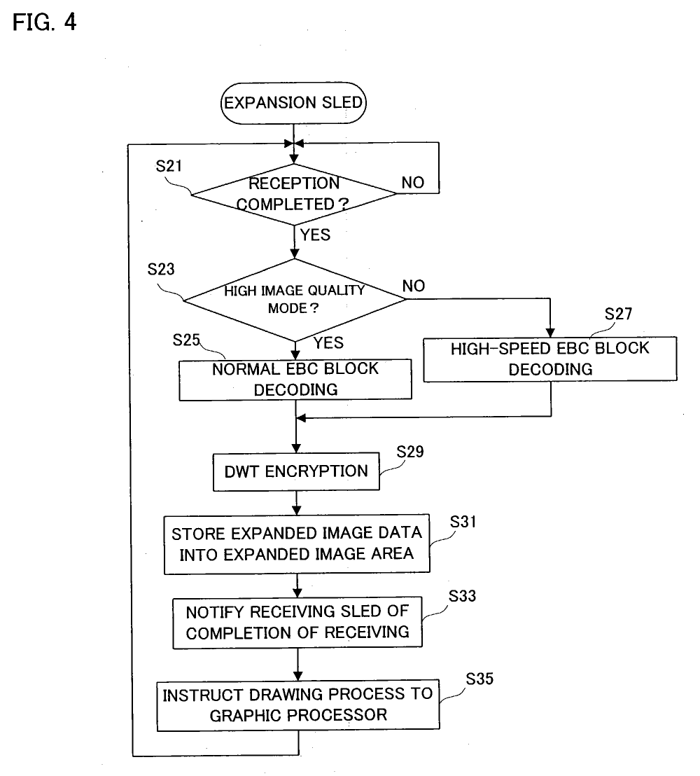

When a fetching operation of the moving image data is carried out by a keyboard 24, the CPU 12 reads out a moving image reproducing program from a hard disk 22 via the chip set 16, and executes the read moving image reproducing program. The moving image reproducing program includes a receiving sled shown in FIG. 3 and an expansion sled shown in FIG. 4, and a receiving process of the moving image data through the NIC 26 and an expansion process of the received moving image data are executed in parallel with each other in accordance with the receiving sled and the expansion sled.

Firstly, referring to FIG. 3, a high image quality mode is validated in a step S1, and it is determined whether or not one frame of the compressed still image data is received in a step S3. Herein, if YES is determined, the process advances to a step S5 so as to write the received compressed still image data into the received image area 18r of the memory 18. In a step S7, the expansion sled is notified of a completion of receiving. In a step S9, it is determined whether or not the expansion process of the compressed still image data of a preceding frame is already completed. At every time that the expansion process of one frame of the compressed still image data is completed, the receiving sled is notified from the expansion sled of the completion of the expansion. In the step S9, YES is determined if the completion of the expansion is already notified, and NO is determined if the completion of the expansion is not yet notified. If YES is determined, the process directly returns to the step S3, and if NO is determined, it is determined whether or not a high image quality fixing mode is selected in a step S11. Then, if YES is determined, the process returns to the step S3, and if NO is determined, the process validates a low image quality mode in a step S13 before returning to the step S3.

It is noted that after the low image quality mode is once validated, the high image quality mode is not to be validated unless the receiving sled is ended or the high image quality fixing mode is manually selected by an operator (by operating the keyboard 24). This makes the second process and the processes that follow in the step S13 meaningless.

Referring to FIG. 4, it is determined whether or not it is notified of the completion of receiving from the receiving sled in a step S21. When it is notified of the completion of receiving, the process advances to a step S23 so as to determine which is validated, the high image quality mode or the low image quality mode. If the high image quality mode is validated, the normal EBC block decoding is executed in a step S25, and if the low image quality mode is validated, the high speed EBC block decoding is executed in a step S27, thereby decoding the respective EBC blocks forming the compressed still image data stored in the received image area 18r.

In a step S29, the inverse DWT processing is subjected to the decoded still image data. Thereby, the still image data corresponding to the respective frequency components are multiplexed with each other, and as a result, expanded still image data is obtained. The expanded still image data generated is written into the expanded image area 18d of the memory 18 in a step S31, and in a succeeding step S33, the receiving sled is notified of the completion of expanding. Upon completion of the process in the step S33, a drawing process is instructed to the graphic processor 14 in a step S35, and then, the process returns to the step S21.

As understood from the above descriptions, when the compressed still image data of the respective frames forming the moving image data fetched from the NIC 26 is expanded, the CPU 12 decodes, in the order of a lower frequency, a plurality of the EBC blocks forming one frame of the compressed still image data. However, a decoding amount of the EBC blocks is controlled based on the frame rate of the moving image data. The still image data corresponding to a plurality of decoded frequency components are multiplexed with each other by the inverse DWT processing, thereby generating one screen of the expanded still image data. Since the amount of the EBC blocks to which the decoding process is subjected is thus controlled based on the frame rate of the moving image data, it is capable of reproducing the moving image at a desired frame rate. Furthermore, when the high image quality fixing mode is manually selected, all the EBC blocks are decoded. This, although it is probable that a reduction in comas may occur, enhances the image quality of the reproduced image.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A moving image reproducing apparatus that reproduces a plurality of encoded image signals generated by encoding, for each frequency component, still image signals of respective screens forming a moving image signal, comprising:
a decoder for decoding, in the order of a lower frequency, a plurality of the encoded image signals corresponding to one screen;
a multiplexer for multiplexing with each other a plurality of the decoded image signals decoded by said decoder so as to generate one screen of a decoded still image signal; and
a controller for controlling a decoding amount by said decoder.

2. A moving image reproducing apparatus according to claim 1, further comprising a fetcher for fetching the moving image signal in a real time, wherein said controller controls the decoding amount based on a fetching period of the still image signal forming the moving image signal.

3. A moving image reproducing apparatus according to claim 2, wherein said controller limits the decoding amount at a time that the fetching period does not satisfy a predetermined condition.

4. A moving image reproducing apparatus according to claim 3, wherein said controller cancels a limitation of the decoding amount when a specific mode is manually selected.
